(19) United States
(12) Patent Application Publication
(10) Pub. No.: US 2008/0249648 A1
(43) Pub. Date: Oct. 9, 2008

(54) SYSTEM FOR VERIFYING APPLICABILITY OF NEW OPERATION RECIPE TO SUBSTRATE PROCESSING APPARATUS

(75) Inventor: Shinichiro Araki, Koshi-Shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TOKYO ELECTRON LIMITED, Tokyo-to (JP)

(21) Appl. No.: 12/026,836

(22) Filed: Feb. 6, 2008

(30) Foreign Application Priority Data
Feb. 7, 2007 (JP) 2007-027524

(51) Int. Cl. G06F 17/00

(52) U.S. Cl. 700/112; 700/121

(57) ABSTRACT

Disclosed is a system which makes it possible to determine whether or not a new operation recipe is applicable to a substrate processing apparatus, the apparatus including plural functional components which operate to perform predetermined tasks to a substrate, and a controller comprising a computer which controls operations of the plural functional components based on an operation recipe including a plurality of operation parameters. An electronic medium storing a new operation recipe and a judgment program is connected to the computer of the substrate processing apparatus. The new operation recipe is retrieved from the electronic medium by means of the computer. The computer executes the judgment program to determine, by using the judgment program, whether or not the new operation recipe can be executed by the functional components.

### TECHNICAL FIELD

The present invention relates to a substrate processing system that performs processing for a substrate such as a semiconductor wafer and a LCD glass substrate, and more particularly to a technique for facilitating updates of a recipe that defines the operation of a substrate processing apparatus.

### BACKGROUND ART

Generally, in manufacturing of a semiconductor device, a photolithography process is used to form an ITO (Indium Tin Oxide) thin film and an electrode pattern on a substrate, such as a semiconductor wafer and a LCD glass substrate. The photolithography process applies a photoresist (hereafter simply referred to “resist”) is applied onto a substrate to form a resist film, exposes the resist film to transfer a predetermined circuit pattern thereon, and develops the resist film, there to form a desired circuit pattern on the resist film.

The above process is generally performed by a coating and developing system, which is provided with a plurality of processing units of various types, such as resist coating units that apply resist liquid onto a substrate, heating units that perform heat treatment for a substrate having been subjected to the resist coating and for a substrate having been subjected to exposure, developing units that supply developing solution to a substrate having been subjected to exposure to perform development, etc.

Each of the units of the above-mentioned coating and developing system is controlled by a controller (control computer) based on a processing recipe. The processing recipe is a set of a number of processing parameters set so as to obtain a target processing result. Although some processing parameters may be set by an operator of the coating and developing system on site, skill is required for this setting. A coating and developing system is also known that has a function to automatically or semi-automatically setting processing parameters in order to reduce the burden on the operator and improve productivity (refer, for example, to JP2005-329306A).

Meanwhile, in the field of substrate processing technique of this type, processing recipes are continually being developed and improved to seek a better processing result.

Semiconductor manufacturing systems are not standardized mass-production products; the details of each semiconductor manufacturing system are often customized according to customer's needs. Further, in many cases, a new recipe is developed using a processing system (processing unit) of the latest design. Therefore, it is difficult to determine whether or not the new recipe is applicable to an existing processing system (processing unit).

### DISCLOSURE OF THE INVENTION

The present invention has been devised in view of the foregoing circumstances, and it is therefore the object of the present invention to provide a technique which makes it possible to readily determine whether or not a new operation recipe (for example, a processing recipe, a transfer recipe) is applicable to an existing substrate processing apparatus.

In order to attain the foregoing objective, according to a first aspect of the present invention, there is provided a system which makes it possible to determine whether or not a new operation recipe is applicable to a substrate processing apparatus, the apparatus including a plurality of functional components which operate to perform predetermined tasks to a substrate, and a controller comprising a computer which controls operations of the plurality of functional components based on an operation recipe including a plurality of operation parameters, wherein the system includes: the substrate processing apparatus; and an electronic medium that can be attached to and detached from the computer of the substrate processing apparatus, or is connected to the computer of the substrate processing apparatus through a communication medium, the electronic medium being readable by the computer of the substrate processing apparatus, wherein: the electronic medium stores the new operation recipe; and the electronic medium or the computer stores a judgment program, executable by the computer, for determining whether or not the new operation recipe stored in the electronic medium can be executed the functional components.

Examples of the electronic medium include a USB (Universal Serial Bus) memory, a hard disk drive, a compact disc, a magnet optical disc, a memory card, and other recording media. The electronic medium may be a recording medium fixedly or detachably provided in another computer that can be connected to the computer of the substrate processing apparatus through a communication medium.

It is preferable that the judgment program be stored in the electronic medium.

The judgment program may be configured so as to determine whether or not specifications of the functional components themselves and/or specifications of software stored in the controller for controlling the operation of the functional components are compatible with the new operation recipe stored in the electronic medium, thereby determining whether or not the new operation recipe stored in the electronic medium is executable.

Preferably, the judgment program has a function to, if the judgment program determines that the new operation recipe stored in the electronic medium is unexecutable, judge the reason therefor and displays it on a display unit.

In another embodiment, the computer of the substrate processing apparatus has a function to automatically determine, based on a part or parts of the plurality of operation parameters, the remaining operation parameters; and the judgment program is configured so as to instruct the computer to determine, based on a part or parts of the plurality of operation parameters included in the new operation recipe stored in the electronic medium, the remaining operation parameters, and so as to compare the operation parameters thus determined with corresponding ones stored in the electronic medium thereby to determine whether or not the new operation recipe stored in the electronic medium is executable.

In one preferred embodiment, a plurality of new operation recipes are stored in the electronic medium; and the judgment program is provided with a function to display preferable new operation recipes on the display in an order determined based on a predetermined criteria if there are a plurality of new executable operation recipes.

The operation recipe may be, for example, a processing recipe that defines a procedure for liquid process to be performed to a substrate by the liquid processing unit. The operation recipe also may be a transfer recipe that defines a procedure for transferring a wafer between processing units in the substrate processing apparatus by a conveyer.

Furthermore, according to the second aspect of the present invention, there is provided an electronic medium for providing a substrate processing apparatus with a new operation recipe, the apparatus including a plurality of functional components which operate to perform predetermined tasks to a substrate, and a controller comprising a computer which controls operations of the plurality of functional components based on an operation recipe including a plurality of operation parameters; wherein the electronic medium stores the new operation recipe including a plurality of operation parameters; and wherein the electronic medium further stores a judgment program, executable by the computer, for determining whether or not the new operation recipe stored in the electronic medium can be executed the functional components.

Furthermore, according to the third aspect of the present invention, there is provided a method of applying a new operation recipe to a substrate processing apparatus, the apparatus includes a plurality of functional components which operate to perform predetermined tasks to a substrate, and a controller comprising a computer which controls operations of the plurality of functional components based on an operation recipe including a plurality of operation parameters, wherein the method includes the steps of: connecting an electronic medium storing the new operation recipe, which has been separated from the computer, to the computer so that the recipe can be read by the computer; retrieving the new operation recipe from the electronic medium by means of the computer; and executing a judgment program by means of the computer to determine, by using the judgment program, whether or not the new operation recipe stored in the electronic medium can be executed by the functional components.

### BRIEF DESCRIPTION OF DRAWINGS

FIG. 1 is a schematic plan view of a resist coating and developing system as an example of a substrate processing system according to the present invention.

FIG. 2 is a schematic perspective view of the resist coating and developing system of FIG. 1.

FIG. 3 is a schematic front elevation view of a liquid processing unit of the resist coating and developing system of FIG. 1.

FIG. 4 is a schematic rear elevation view of a heat treatment unit of the resist coating and developing system of FIG. 1.

FIG. 5 is a block diagram showing components related to the determination of the compatibility of a recipe in the resist coating and developing system of FIG. 1.

FIG. 6 is a schematic sectional view showing a configuration of a developing unit included in the resist coating and developing system of FIG. 1.

FIG. 7 is a schematic plan view of the developing unit of FIG. 6.

FIG. 8 is a sectional view showing a configuration of a processing liquid supply nozzle shown in FIGS. 6 and 7.

FIG. 9 is a schematic sectional view showing a developing unit which includes a processing liquid supply nozzle different from the one shown in FIG. 8.

FIG. 10 is a schematic plan view of the developing unit of FIG. 9.

FIG. 11 is a sectional view showing a configuration of the processing liquid supply nozzle shown in FIGS. 9 and 10.

FIG. 12 is a flow chart explaining a processing procedure performed in the resist coating and developing system of FIG. 1.

### DESCRIPTION OF PREFERRED EMBODIMENTS

Preferred embodiments of the present invention will be explained in detail below with reference to the accompanying drawings. Here, as an example of a substrate processing system according to the present invention, a resist coating and developing system which performs a series of processes including a resist coating process and a developing process to a semiconductor wafer will be explained below.

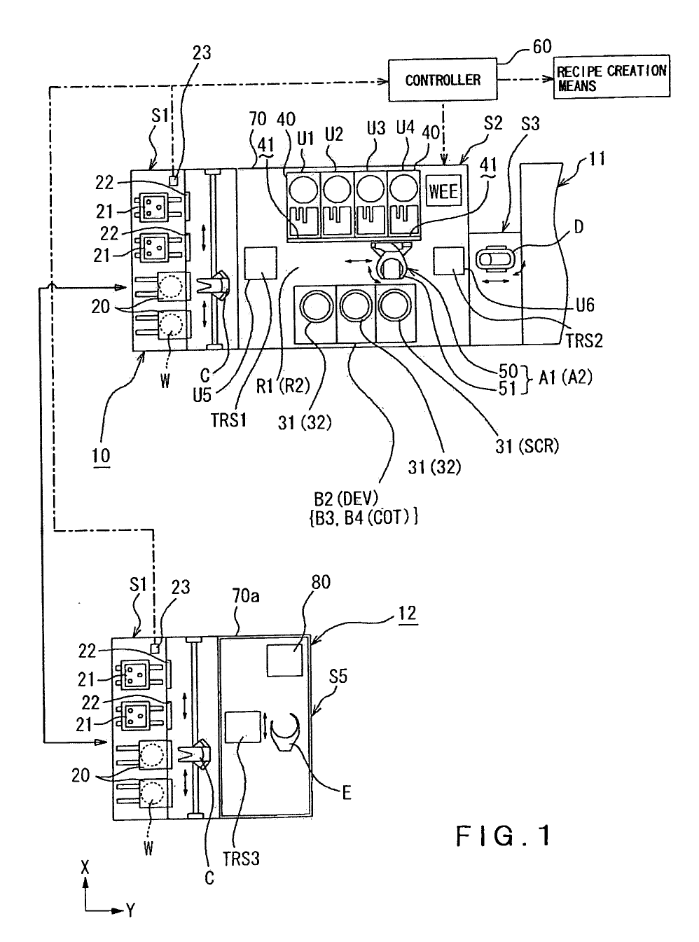

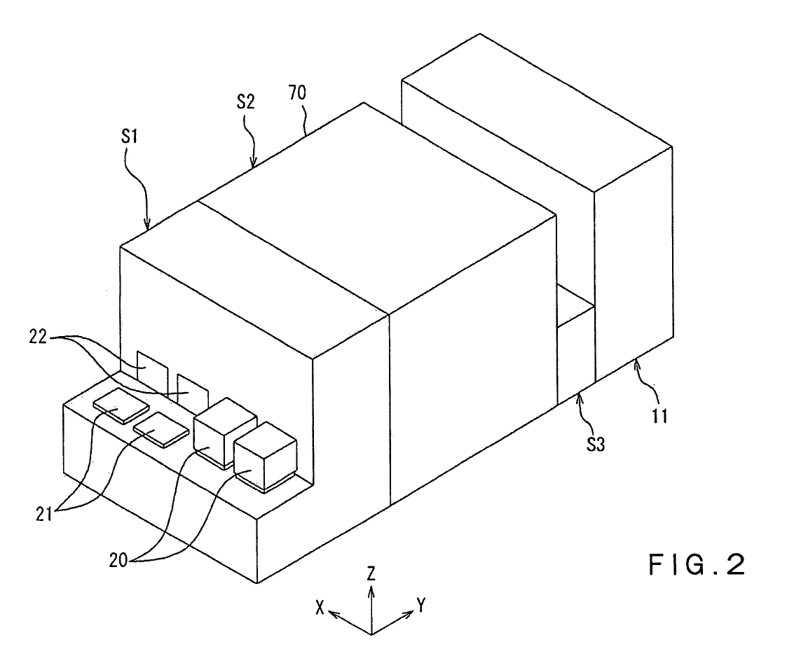

FIG. 1 is a schematic plan view of a resist coating and developing system, and FIG. 2 a schematic perspective view thereof.

The resist coating and developing system includes a resist coating and developing apparatus 10, which includes: a carrier block S1 for transferring carriers 20 each storing, for example, 25 sheets of semiconductor wafer W (hereafter simply referred to as “wafer W”), i.e., substrates subjected to processing, into or out of the system; a coating and developing block S2 (hereafter simply referred to as “processing block S2”) composed of a plurality of unit blocks, for example four unit blocks B1 to B4, vertically arranged; and an interface block S3. The resist coating and developing system further includes: an exposure apparatus 11 which is connected with the resist coating and developing apparatus 10 in an in-line manner; and an etching apparatus 12 which includes a carrier block S1 for transferring carriers 20 into or out of the apparatus, and an etching block S5 having an etching unit 80. In the resist coating and developing apparatus 10, arms A1, A2, C, D, and E to be mentioned later are provided as conveying units for transferring the wafer W to and from each of the blocks S1 to S3, processing units in each block, and processing units in the etching block S5.

Each of the carrier blocks S1 of the resist coating and developing apparatus 10 and the etching apparatus 12 is provided with tables 21 on each of which a plurality of (for example, four) carriers 20 can be placed; a plurality of shutters 22 each provided at a wall formed anteriorly (meaning the positive direction of the Y axis of FIG. 1, similarly below) to the table 21; and a transfer arm C for taking a wafer W out of the carriers 20 through the shutters 22.

The transfer arm C of the resist coating and developing apparatus 10 is arranged movably in the horizontal X and Y directions and in the vertical Z direction and rotatably around its vertical axis so as to transfer the wafer W to and from a transfer stage TRS1 provided on the processing block S2.

The transfer arm C of the etching apparatus 12 is arranged movably in the horizontal X and Y directions and in the vertical Z direction and rotatably around its vertical axis so as to transfer the wafer W to and from a transfer stage TRS3 provided on the etching block S5.

In the vicinity of each shutter 22 of the carrier blocks S1, there is provided detection means 23 for reading an identification tag (not shown) attached to a carrier 20 to recognize the processing history of wafers W stored in the carrier 20, i.e., the number of times of processes previously performed to the wafer W.

The detection means 23 is electrically connected to a controller 60, i.e., control means, so that a signal detected by the detection means 23 is transmitted to the controller 60. This makes it possible to determine whether the process to be performed to the wafer W is the first process or second or subsequent process.

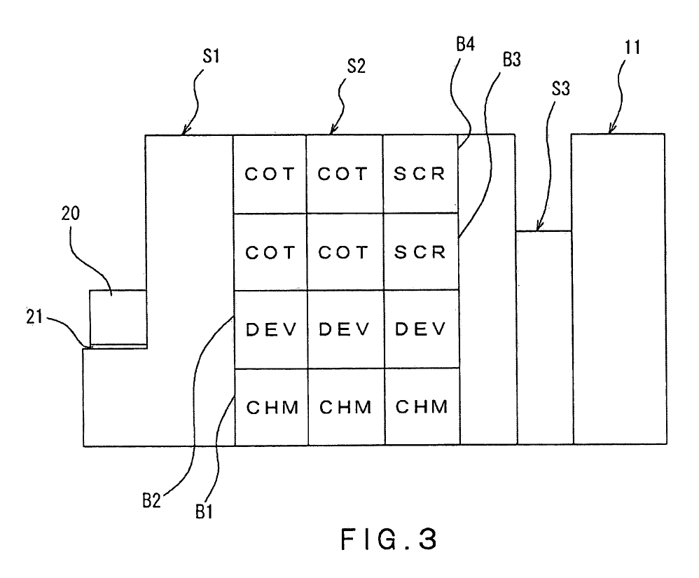

The processing block S2 enclosed in a housing 70 is connected anteriorly to the carrier block S1. The processing block S2 is provided with, from the bottom upward, a first unit block (CHM) B1 for storing containers of chemical solutions such as a resist solution and a developing solution; a second unit block (DEV layer) B2 for performing a developing process; and third and fourth unit blocks (COT layers) B3 and B4, that is, two layers for performing a resist solution coating process each of which layers includes a coating-film-forming unit block and a cleaning unit block for performing a cleaning process (refer to FIG. 3). Here, it is possible to replace one of the unit blocks for forming a coating film, for example, the third unit block (COT layer) B3 with a unit block (BCT layer) for forming an antireflective film to be formed on the lower side of the resist film. Further, it is possible to provide a unit block for forming an antireflective film to be formed on the upper side of the resist film on a fourth unit block (COT layer) B4.

The first to fourth unit blocks B1 to B4 are provided with a plurality of liquid processing units, arranged on the right-hand side of the processing block S2, for performing various liquid processes to the wafer W; a plurality of heat treatment units (and processing units of other types), arranged on the left-hand side of the processing block S2, for performing various thermal processes as a pre-treatment and post-treatment of the liquid process; and main arms A1 and A2 which are dedicated substrate transfer means for transferring the wafer W to and from the foregoing various types of processing units.

The unit layout is almost the same for the unit blocks B1 to B4. That is, the central position for placing the wafer W in each processing unit (for example, the central position of a spin chuck which is means for holding the wafer W in the liquid processing units and the central position of a heating plate or a cooling plate in the heat treatment units) is almost the same for each unit block.

As shown in FIG. 1, almost at the center of the DEV layer B2, a wafer W transfer area R1 (horizontal movement area of the main arm A1) is provided in the longitudinal direction (Y direction of FIG. 1) of the DEV layer B2 with both ends thereof communicating with the etching block S5 and the interface block S3. Further, although not shown, like the DEV layer B2, almost at the center of COT layers B3 and B4, a wafer W transfer area R2 (horizontal movement area of the main arm A2) which connects to the carrier block S1 and the interface block S3 is provided in the longitudinal direction (Y direction of FIG. 1) of the COT layers B3 and B4.

On the right-hand side (meaning the negative direction of the X axis of FIG. 1, similarly below) of the transfer area R1 (R2), three developing units 31a, 31b, and 31c for performing the developing process, four resist coating units 32a and 32b, and two cleaning units (SCR) are provided as liquid processing units (refer to FIGS. 1 and 3).

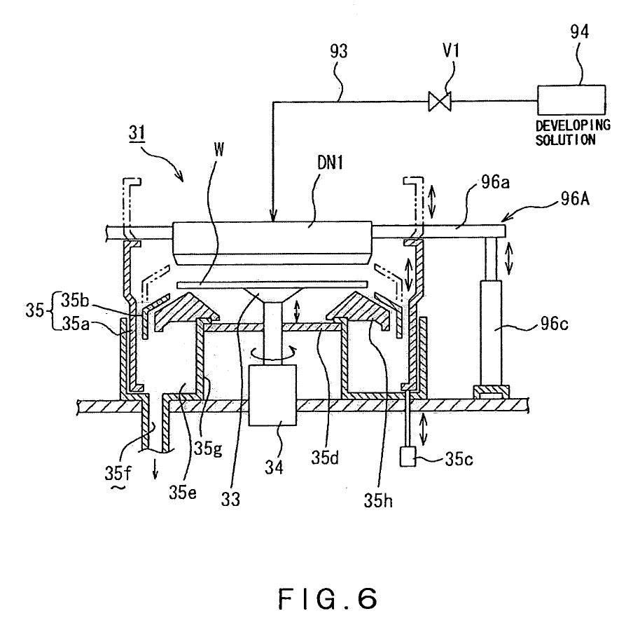

As shown in FIG. 6, the developing unit 31 comprises: a spin chuck 33 which attaches thereto a wafer W with vacuum to support it approximately horizontally; a motor 34 which rotates the spin chuck 33 and moves it up and down; a cup 35 arranged so as to surround the side face of the wafer W with the wafer W attached to and supported by the spin chuck 33; a processing liquid supply nozzle DN1 (hereafter simply referred to as “supply nozzle DN1”) which supplies a processing liquid, for example developing solution, onto the surface of the wafer W supported by the spin chuck 33; and a cleaning fluid supply nozzle RN (hereafter simply referred to as “cleaning nozzle RN”) which supplies cleaning fluid, for example pure water, onto the surface of the wafer W.

The cup 35 includes an outer cup 35a and an inner cup 35b which are both vertically movable. The upper part of the inner cup 35b is inclined so that the upper opening thereof is smaller than the lower opening thereof. The outer cup 35a can be moved up and down by an elevating unit 35c. The inner cup 35b is arranged so as to move up and down in conjunction with the outer cup 35a within a part of the moving range of the elevated outer cup 35a.

The lower part of the cups 35 is composed of a disc 35d which surrounds the shaft of the spin chuck 33, and a reservoir 35g having a concave portion 35e circumferentially extending along the disc 35d and a drain outlet 35f at the bottom. The outer cup 35a and the inner cup 35b are arranged slightly inside the side face of the reservoir 35g so as to be contained therein, and the upper and lower parts of the side face of the wafer W are surrounded by the concave portion 35e and the cups 35. A ring 35h having an approximately triangular-shaped cross-section is provided at the edge portion of the disc 35d, with the ring arranged so that the top edge thereof comes close to the bottom side of the wafer W.

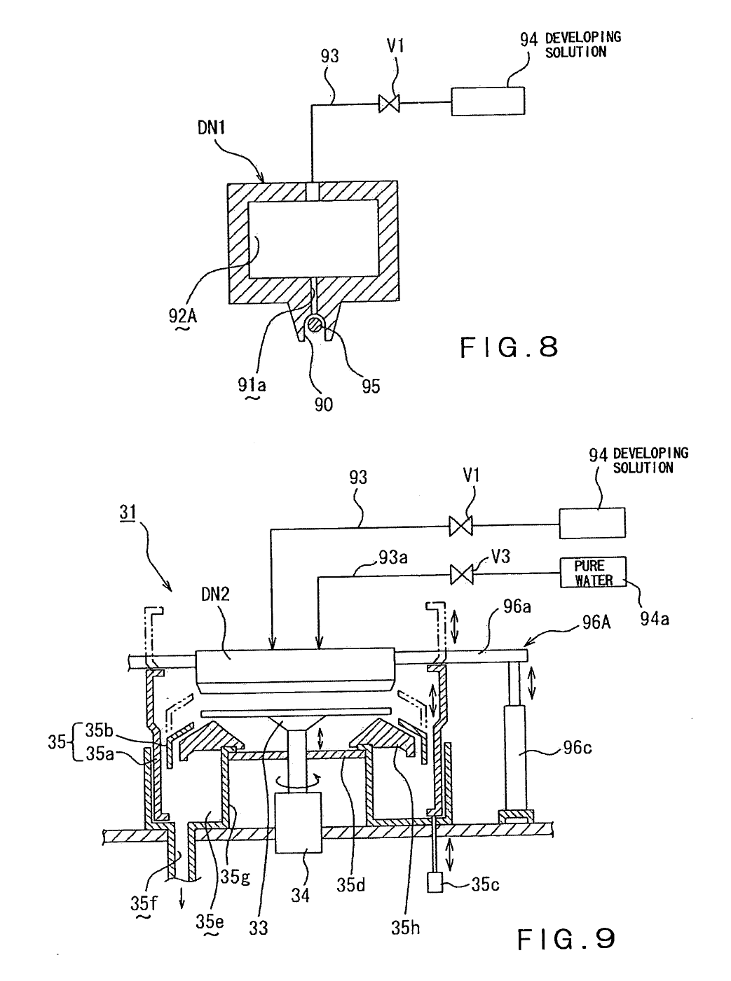

As shown in FIGS. 6 and 8, the supply nozzle DN1 is formed as a slit nozzle which is provided with a number of discharge ports 90 arranged in the longitudinal direction of the supply nozzle DN1 and a developing solution reservoir 92A communicating with the discharge ports 90 through a developing solution channel 91a, so as to ensure a discharge range of the processing liquid over a length which is equal to or greater than the width of the effective area (device formation area) of the wafer W.

The developing solution reservoir 92A is connected to a developing solution supply source 94 through a supply pipe 93 with an open/close valve V1 provided between the pipe 93 and the supply source 94. Inside the discharge port 90, a bar-like body 95 made of quartz or ceramic is arranged as a buffer material. The bar-like body 95 is provided on an imaginary extension of the developing solution channel 91a and without contact with the inner wall of the discharge port 90 (except for portions that support both ends of the bar-like body 95) so as to ensure in the longitudinal direction of the supply nozzle DN1 a uniform discharge pressure of developing solution discharged from the developing solution channel 91a through the discharge port 90 toward the surface of the wafer W. Therefore, the developing solution once collides against the bar-like body 95 and then goes downward to the wafer W.

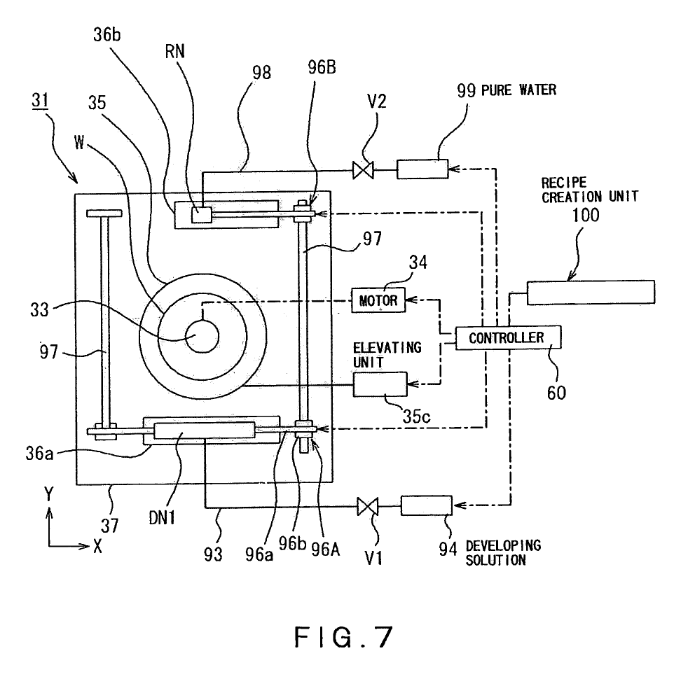

The supply nozzle DN1 is arranged so as to be movable above the wafer by means of a first movement mechanism 96A, along a pair of guide rails 97 provided on the outside of the cup 35, from a standby position 36a on the outside of the cup 35 (on one end side of the guide rails 97) to an opposite standby position 36b across the wafer W, as shown in FIG. 7.

The first movement mechanism 96A is composed of an arm 96a and a base 96b. The arm 96a supports the supply nozzle DN1 so that the processing liquid discharge ports 90 are arrayed in the X direction shown in FIG. 7. The arm 96a is formed so as to move along the guide rails 97 by means of the base 96b, i.e., a moving body. The arm 96a can be vertically moved by an elevating mechanism 96c arranged between the arm 96a and the base 96b.

The cleaning nozzle RN, formed as a straight nozzle, is connected to a cleaning liquid (pure water) supply source 99 through a cleaning liquid supply pipe 98 with an open/close valve V2 provided between the supply source 99 and the supply pipe 98, as shown in FIG. 7. The supply nozzle DN1 is movably arranged by means of a second movement mechanism 96B so as to horizontally move above the wafer W from the standby position 36b on the outside of the cups 35 (on the other end side of the guide rails 97) to the standby position 36a of the cleaning nozzle RN1, as shown in FIG. 7.

The cups 35, the first movement mechanism 96A, and the second movement mechanism 96B are surrounded by a box-shaped housing 37. The wafer W is transferred into/out of the housing 37 by the main arm A1 through a transfer opening (not shown).

The motor 34, the elevating unit 35c, the first and second movement mechanisms 96A and 96B, and the open/close valves V1 and V2 are each connected with the controller 60. The controller 60 can interconnected control for rotation and vertical movement of the spin chuck 33, opening and closing of the open/close valves V1 and V2, movement (scanning) of the nozzles by the first and second movement mechanisms 96A and 96b, and the like. In this case, the controller 60 controls supply timing of a processing liquid such as developing solution and pure water, i.e., open/close timing of the open/close valves V1 and V2; start/stop timing and moving speed of the first and second movement mechanisms 96A and 96B; the height of the supply nozzle DN1 when the developing solution (diluting liquid) is discharged; etc., based on a processing recipe created in advance by recipe creation means 100 to be mentioned later.

A processing recipe for a developing process is a set of various processing parameters that define processing procedures and conditions for the developing process. The processing parameters include parameters to be controlled, such as the developing solution temperature, the discharge timing, the discharge time period, and the discharge flow rate of developing solution or diluting liquid (pure water) from the supply nozzle DN, a vertical position and scan speed of the supply nozzle DN, a rotating speed and rotation time of the spin chuck, etc. The processing parameters also include parameters not to be controlled, such as developing solution viscosity (that is, a kind of developing solution), target line width, etc.

The recipe creation means 100 has a function to automatically determine (calculate or select), based on specified parameters input from an input unit 101, other parameters. The recipe creation means 100 can be formed by, for example, a general-purpose computer.

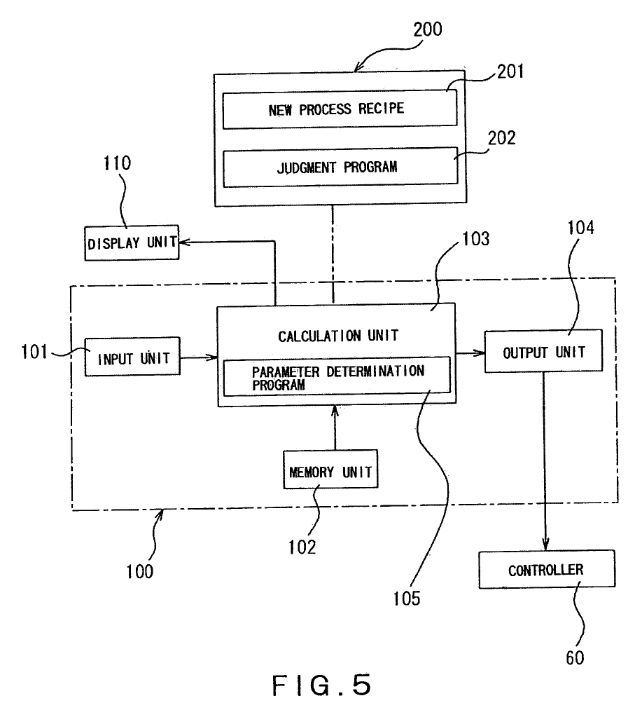

As shown in FIG. 5, the recipe creation means 100 has the input unit 101, a memory unit 102, a calculation unit 104, and an output unit 104. When specified parameters (i.e., parameters that must be attained) are input to the calculation unit 104 via the input unit 100, the calculation unit 104 activates a parameter determination program 105 to determine all parameters other than the specified parameters through arithmetic operations or based on correlation data indicating the correlation among the plurality of parameters stored in the memory unit 102. The determination of processing parameters through arithmetic operations is used to determine parameters which can be uniquely determined by other parameters. For example, if scanning speed and discharge time are specified, the discharge timing can be determined through simple arithmetic operations. The determination of processing parameters using correlation data is used to determine parameters which are closely related to the fluid behavior of the developing solution, chemical reaction, etc. For example, if a developing solution temperature etc. changes, it may be difficult to obtain related parameters (for example, development time) through simple arithmetic operations in order to obtain a desired result of development. In this case, suitable parameters corresponding to specified parameters are determined based on the correlation among the processing parameters obtained in advance through an experiment. The correlation can be stored in the memory unit 102, for example, in the form of a function or a map. A processing recipe created by the recipe creation means 100 is output to the controller 60, and the controller 60 controls the developing unit 31 based on the processing recipe. Further, the processing recipe created by the recipe creation means 100 is sent to a display unit 110, such as a display, to be displayed. Processing recipes for the processes previously executed by the developing unit and the associated processing results are stored in the memory unit 102. As the parameter determination function itself of the recipe creation means 100 is disclosed, for example, in JP2005-329306A, the details thereof will not be further explained herein.

An example of developing process performed according to a processing recipe created by the recipe creation means 100 will be briefly explained below. First, in a state where the spin chuck 33 holds the wafer W by suction, the supply nozzle DN1 discharges the developing solution for five seconds while moving above the wafer W without the spin chuck being rotated (i.e., the rotational speed of the spin chuck is 0 rpm) to apply the developing solution on the wafer W (Step 1). After discharge of the developing solution is stopped, the development reaction is promoted by leaving the wafer as it is for a predetermined period of time, for example, about 60 seconds, with the rotation of the spin chuck 33 kept stopped (Step 2). Subsequently, the wafer W is rotated at a rotational speed of about 1000 rpm while the pure water is supplied from the cleaning nozzle RN to the wafer surface for 15 seconds to wash out the developing solution from the wafer surface (Step 3). Then, the supply of the pure water is stopped, and the wafer W is dried by rotating the wafer W at a high speed, for example, a rotational speed of about 4000 rpm, for 15 seconds (Step 4).

As explained in the section “BACKGROUND ART”, processing recipes are constantly improving. It is preferable to apply improved processing recipes (optimal at present) as required. Therefore, a storage medium, for example, a USB memory 200 which stores a processing recipe optimized by new processing parameters can be electrically connected to the recipe creation means 100. As shown in FIG. 5, the USB memory 200 includes a processing recipe information storage unit 201, which stores processing parameters that define an optimized processing recipe.

If the optimized processing recipe is developed using a developing unit having completely the same specifications as those of the developing unit 31, it may be applied to the developing unit 31 without problems; otherwise, it is difficult or very time consuming to determine whether or not the recipe can be applied to the developing unit 31. In order to solve this problem, the USB memory 200 further includes a judgment program storage unit 202 which stores a judgment program which determines whether or not the developing unit 31 can perform a developing process according to the processing recipe stored in the processing recipe information storage unit 201. The calculation unit 104 of the recipe creation means 100 comprising a computer accesses the USB memory 200 to read out the judgment program from the judgment program storage unit 202 and execute it, thereby determining whether or not the developing unit 31 can execute the processing recipe stored in the processing recipe information storage unit 201.

The developing unit 31 cannot execute the processing recipe in the following cases: (1) The hardware of the developing unit 31 (various functional devices) is not capable of attaining processing parameters defined by the processing recipe; or (2) the software (specifically, a control program stored in the controller 60) for controlling the hardware of the developing unit may be unable to respond to the processing parameters even if the hardware has sufficient capability.

For example, the case (1) includes the following exemplified cases:
The nozzles DN1 and DN2 are not configured in such a way as to supply the developing solution or pure water in ways defined by a processing recipe;
The capability of the motor 34 (for example, acceleration/deceleration performance) cannot respond to the processing parameters;
The movement mechanisms 96A and 96B of the nozzles cannot control the moving speed and position corresponding to the processing parameters;
The elevating unit 35c cannot control nozzle height (that is, the distance between the substrate and the nozzle end) in a non-step manner (for example, the elevating unit 35c is composed of an air cylinder);
The developing solution/pure water supply system cannot respond to the processing parameters (for example, unable to change its supply flow rate) because of valve specifications, etc.; and
Although a processing recipe can execute the following step only after checking the operating status of functional devices through a sensor, there is no necessary sensor.

An example of a procedure for determining whether or not the developing unit 31 can execute the processing recipe stored in the USB memory 200 will be explained below. Basic performance (for example, the acceleration/deceleration capability of the motor 34, the position control capability of the nozzle DN1 by the movement mechanism 96A of the nozzle) of each functional device (functional component) included in the developing unit 31 is stored in the memory unit 102. The judgment program reads out the basic performance of each device and determines whether or not processing parameters included in the processing recipe stored in the USB memory 200 are feasible. Then, the judgment program accesses the control program in the controller 60 and determines whether or not the control program is configured such that it can execute the processing recipe stored in the USB memory 200.

Another example of the procedure for determining whether or not the developing unit 31 can execute a processing recipe stored in the USB memory 200 will be explained below. The judgment program specifies requisite processing parameters included in a processing recipe stored in the USB memory 200 as specified parameters, and instructs the parameter calculation program 105 to calculate the other processing parameters. The judgment program compares the processing parameters determined through calculation with corresponding parameters stored in the USB memory 200, and, if they coincide with each other, may judge that the processing recipe stored in the USB memory 200 is executable. The number of combinations of other parameters determined by the parameter calculation program 105 based on the specified parameters is not limited to one, but may be plural. In this case, therefore, if at least one of the plural parameter combinations coincides with the corresponding parameter combination stored in the USB memory 200, it is possible to judge that the processing recipe stored in the USB memory 200 is executable.

If a processing recipe stored in the USB memory 200 is judged to be executable, the display unit 110 displays the fact that “it is executable”, and at the same time the data in the USB memory 200 is stored in the memory unit 102. When processing is performed, this processing recipe is output to the controller 60 through the output unit 104.

If the processing recipe stored in the USB memory 200 is judged to be unexecutable, the fact that “it is unexecutable”, preferably the reason therefor additionally, and more preferably a suggestion of means for making the recipe executable additionally (replacement of devices such as a nozzle, update of the control program, etc.) may be displayed on the display unit 110. It is preferable to embed in the judgment program a function to present the reasons that the recipe is unexecutable and means for making it executable.

The judgment program may be previously stored in the recipe creation means 100. However, since it is highly possible that a new judgment program is necessary to determine whether or not a new processing recipe is executable, it is preferable to embed the judgment program together with the new processing recipe in the USB memory 200.

The USB memory 200 may store a plurality of processing recipes. If a plurality of executable recipes are included in the stored processing recipes, it is possible to display them on the display unit 110 in the order of favorability (i.e., priority order display). The priority order can be determined based on, for example, shorter processing time or less developing solution consumption. The operator may be allowed to set criteria in determining the priority order through the input unit 101. Further, the operator may be allowed to select one of the executable recipes through the input unit 101. These functions may also be embedded in the judgment program.

It is also possible to give a password or the like to data of a processing recipe stored in the USB memory 200 to encrypt the processing recipe. This makes it possible to prevent the information of an optimal processing recipe from being leaked carelessly to outsiders.

In the foregoing embodiment, the recipe creation means 100, which is embodied by a computer and has an automatic recipe creation function, determines whether or not a recipe stored in the USB memory 200 is executable. Typically, it is likely that such a recipe creation means 100 has data, which relate to the performance (operable range, etc.) of each of functional components constituting the developing unit 31 and which relate to the control functions of the controller 60. Accordingly, it is efficient and preferable to determine whether or not a recipe is executable, by using the recipe creation means 100. However, it is not always necessary to use the recipe creation means 100, having the automatic recipe creation function, to determine whether or not a recipe is executable. It is sufficient that the judgment program can grasp the performance (operable range, etc.) of each of functional components constituting the developing unit 31 and the control functions of the controller 60 in a certain way. For example, it is possible to provide a database of the performance (operable range, etc.) of each of functional components instead of the recipe creation means 100. Further, although the recipe creation means 100 and the controller 60 are described as separate component members in FIG. 5, it is possible to attain the functions of the recipe creation means 100 and the controller 60 by means of a single computer.

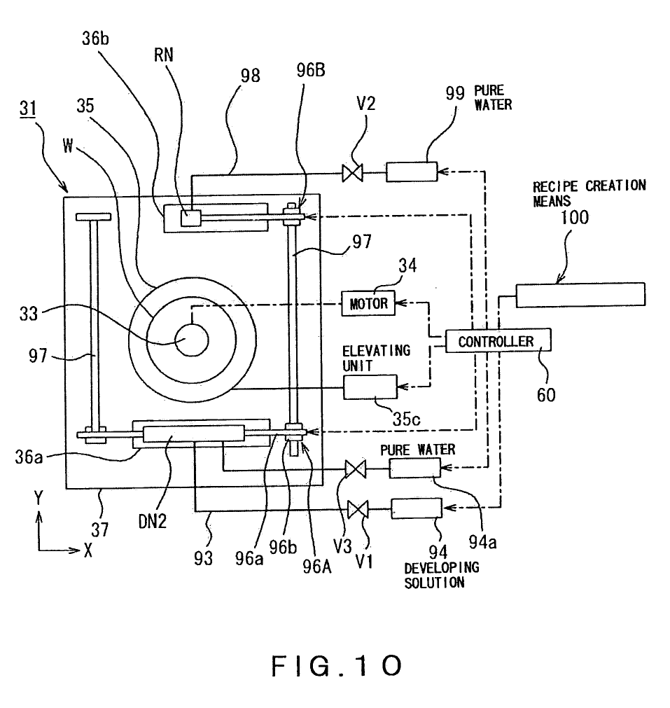

The following explains a case where a processing recipe stored in the USB key 200 can be executed by replacing the supply nozzle DN1 with the supply nozzle DN2 of a composite slit type which supplies the developing solution and diluted solution (pure water) as shown in FIGS. 9 to 11.

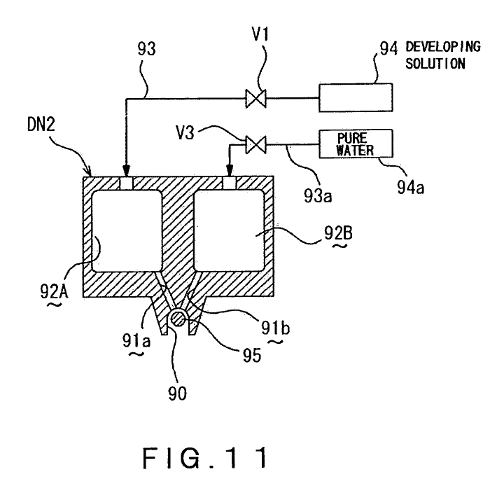

As shown in FIGS. 9 and 11, the supply nozzle DN2 is provided with a number of discharge ports 90 arranged in the longitudinal direction of the supply nozzle DN2, the developing solution reservoir 92A communicating with the discharge ports 90 through the developing solution channel 91a, and the pure water reservoir 92B communicating with the discharge ports 90 through a pure water channel 91b.

The developing solution reservoir 92A is connected to the developing solution supply source 94 through the supply pipe 93 with the open/close valve V1 provided between the supply pipe 93 and the supply source 94 and to a diluted solution supply source, for example, a pure water supply source 94a through a second supply pipe 93a with an open/close valve V3 provided between the supply pipe 93a and the supply source 94a. With the switching between the open/close valves V1 and V3, the developing solution, supplied from the developing solution supply source 94 through the supply pipe 93 to the developing solution reservoir 92A, is discharged from the discharge ports 90 through the developing solution channel 91a, or the pure water, supplied from the pure water supply source 94a through the second supply pipe 93a to the pure water reservoir 92B, is discharged from the discharge ports 90 through the pure water channel 91b.

Inside the discharge port 90, the bar-like body 95 made of quartz or ceramic is arranged as a buffer material. The bar-like body 95 is provided on an imaginary extension of each of the channels 91a and 91b and without contact with the inner wall of the discharge port 90 (except for portions that support both ends of the bar-like body 95) so as to ensure in the longitudinal direction of the supply nozzle DN2 a uniform discharge pressure of the developing solution (diluting liquid) discharged from the channel 91a and 91b, respectively, through the discharge ports 90 toward the surface of the wafer W. Therefore, the developing solution (diluting liquid) once collides against the bar-like body 95 and then goes downward to the wafer W.

Like the foregoing supply nozzle DN1, the supply nozzle DN2 is attached to the arm 96a and moved by the first movement mechanism 96A.

Developing process using the supply nozzle DN2 is performed as follows. First, in a state where the spin chuck 33 holds the wafer W by suction, the supply nozzle DN2 discharges the developing solution for five seconds while moving above the wafer W without the spin chuck 33 being rotated (the rotational speed of the spin chuck is 0 rpm) to apply the developing solution on the wafer W (Step 1). After discharge of the developing solution is stopped, the development reaction is promoted by leaving the wafer as it is for a predetermined period of time, for example, about 10 seconds, with the rotation of the spin chuck 33 kept stopped (Step 2). Here, the coating of the wafer with the developing solution (Step 1) and leaving the wafer W as it is thereafter (Step 2) are conducted with the wafer W in a stationary state. During these steps, therefore, the developing solution applied onto the wafer surface is also generally in a stationary state. Therefore, immediately after the start of Step 2, dissolution products of a resist film are accumulated in high concentration in the vicinity of exposed portions.

After the exposure areas are dissolved in the foregoing manner, the open/close valve V3 is opened to supply the pure water from the pure water supply source 94a of the supply nozzle DN2, thereby starting the discharge of the pure water from the discharge ports 90. At the same time, the spin chuck 33 is rotated at a low speed, for example, 10 rpm. The pure water supply and the spin chuck rotation are continued for five seconds. The pure water supply is started at a time point when dissolution of the resist film on the exposure area has proceeded to the bottom thereof but a CD (line width) value before the diffusion of the generated dissolution products into the developing solution has hardly been affected. Specifically, for example, the pure water supply is started in ten seconds after completion of application of the developing solution to the wafer W. Then, by supplying the pure water while rotating the wafer W, the developing solution with an increasing concentration of the dissolution products is replaced with the pure water (Step 3). This makes it possible to avoid the possibility that the dissolution products in the exposure areas cause an adverse influence on CD values or defective development.

Upon completion of Step 3, the pure water supply and wafer W rotation are stopped, and the wafer W is left as it is for about five seconds (Step 4). Then, the discharge portion of the cleaning nozzle RN is positioned above the center of the wafer W by the second movement mechanism 96B. At the same time, while the spin chuck 33 is rotated at a rotational speed of about 1000 rpm, a cleaning liquid, for example pure water, is supplied to the center of the wafer W from the cleaning nozzle RN, and the cleaning liquid is spread from the center of the wafer W to the edge portion thereof by the centrifugal force to flush away the developing solution and dissolution products (Step 5). Step 5 is continued for fifteen seconds. Then, the pure water supply is stopped, and the wafer W is rotated at high speed, for example, a rotational speed of about 4000 rpm, to dry the wafer W (Step 6). This completes developing process, and then the wafer W is transferred out of the developing unit 31.

Although the above explanation has been made in connection with the developing unit 31, it is also possible for the resist coating unit 32 to determine whether or not a new processing recipe is executable in the same manner as above. In the case of resist coating process, exemplified processing parameters include target thickness of the resist film, resist liquid viscosity, a discharge flow rate of the resist liquid, discharge timing of the resist liquid, a gap between the resist coating nozzle and the wafer, scanning speed of the resist coating nozzle, etc. It is also possible to determine whether or not a new processing recipe is executable for other processing units, such as the cleaning units (SCR), an edge exposure unit (WEE), the thermal treatment units, etc. in the same manner as above. Also for a transfer recipe which specifies a procedure for transferring the wafer W, it is possible to determine whether or not the transfer recipe is executable by diagnosing the transfer capability of each transfer arm constituting the conveying system and the arrangement and function of each processing unit. That is, the present invention can be widely used to determine the compatibility of operation recipes that define operating procedures of various functional components included in the substrate processing system by means of a plurality (large number) of operation parameters.

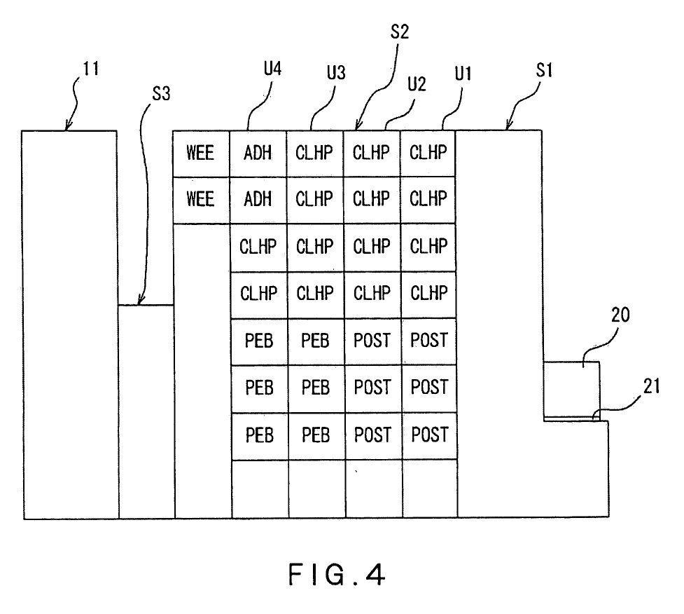

As shown in FIGS. 1 and 4, four unit racks U1, U2, U3, and U4 composed of a number of heat treatment units arranged in layers is provided on the left-hand side of the transfer area R1 (R2). As shown particularly in the FIG. 4, at a position corresponding to DEV layer B2, heat treatment units for performing the pre- and post-treatments of the developing process performed by the developing unit 31 are arranged in three layers. The developing units 31a to 31c and the unit racks U1 to U4 are separated from each other by the transfer area R1. Clean air is blown into the transfer area R1 and is discharged therefrom, thus restraining particles floating therein.

The foregoing units which perform the pre- and post-treatments of the developing process include a post-exposure baking unit (PEB) which heats the exposed wafer W and a post baking unit (POST) which heats the wafer W to remove moisture from the developed wafer W. The heat treatment units (PEB, POST, etc.) are stored in their respective processing container 40. Each of the unit racks U1 to U4 includes three processing containers 40 arranged in layers at the height position corresponding to the DEV layer B2. A wafer transfer opening 41 is formed on the surface which faces the transfer area R1 of the processing container 40. The heat treatment units (PEB and POST) are electrically connected with the controller 60 to control heating temperature, heating time, and other heating conditions based on a control signal from the controller 60.

The main arm A1 is provided in the transfer area R1. The main arm A1 is arranged movably in the horizontal X and Y directions and in the vertical Z direction and rotatably around its vertical axis so as to transfer the wafer W to and from all locations (units and stages) in the DEV layer B2 where the wafer W is placed, for example, the heat treatment units in the unit racks U1 to U4 and the developing units 31a to 31c.

Since the main arms A1 and A2 have the same configuration, the configuration of only the main arm A1 will be explained below. As shown in FIG. 1, the main arm A1 is provided with an arm unit 50 having two curved arm pieces 51 for supporting the edge portion of the back surface of the wafer W. These curved arm pieces 51 are retractable independently of each other with respect to a base (not shown). The base is arranged rotatably around its vertical axis, movably in the Y direction, and movably in the vertical directions. Therefore, the curved arm pieces 51 are arranged retractably in the X direction, movably in the Y direction, movably in the vertical directions, and rotatably around the vertical axis so as to transfer the wafer W to and from each unit in the unit racks U1 to U4, the transfer stage TRS1 on the unit rack U5 arranged on the side of the carrier block S1, and the liquid processing units (COT, DEV, and SCR). The drive of the main arm A1 (A2) is controlled by a controller (not shown) based on a command from the control section 60. Further, in order to prevent heat accumulation in the main arm A1 (A2) by the heat generated by the heating units, a program is used to arbitrarily control the order of receiving the wafer W.

Each of the unit blocks B3 and B4 for forming a coating film has almost the same configuration. Each of the unit blocks B3 and B4 is provided with resist coating units 32a and 32b, respectively, for performing the resist liquid coating process. Provided at a height position corresponding to the COT layers B3 and B4 in the unit racks U1 to U4 are a heating unit (CLHP) for heating the wafer W that completed resist liquid coating and a hydrophobizing unit (ADH) for improving the adhesion between the resist liquid and the wafer W. The resist coating units 32a and 32b, the heating units (CLHP) of the unit racks U1 to U4, and the hydrophobizing unit (ADH) are separated by the transfer area R2 (horizontal movement area of the main arm A2). In the COT layers B3 and B4, the wafer W is transferred to and from the transfer stage TRS1 on the unit rack U5, the resist coating units 32a and 32b, and each processing unit in the unit racks U1 to U4 by means of the main arm A2. The hydrophobizing unit (ADH) which performs gas processing in the HMDS atmosphere only needs to be provided in either the unit block B3 or B4.

As shown in FIG. 1, in an area adjoining the interface block S3 of the processing block S2, a unit rack U6 is provided at a position that can be accessed by the main arm A1. The unit rack U6 is provided with a transfer stage TRS2 that allows transfer of the wafer W to/from the main arm A1 of the DEV layer B2 and also with another transfer stage (not shown) having a cooling function. Further, as shown in FIGS. 1 and 4, in the area adjoining the interface block S3 of the processing block S2, two edge exposure units (WEE) are provided.

The exposure apparatus 11 is connected anteriorly to the unit rack U6 of the processing block S2 through the interface block S3. The interface block S3 is provided with an interface arm D for transferring the wafer W to/from each unit or stage on the unit rack U6 of the DEV layer B2 of the processing block S2 and the exposure apparatus 11. The interface arm D constitutes wafer W transfer means arranged between the processing block S2 and the exposure apparatus 11. An interface arm F is arranged movably in the horizontal X and Y directions and in the vertical Z direction and rotatably around its vertical axis so as to transfer the wafer W to and from the transfer stage TRS2 on the unit rack U6, etc.

The etching block S5 of the etching apparatus 12 is provided with a housing 70a in which a plurality of (four herein) etching units (dry etching apparatuses) 80 are arranged in layers. In the housing 70a, a transfer arm E for transferring the wafer W into or out of each etching unit 80 and a transfer stage TRS3 are arranged. The transfer arm E is arranged movably in the horizontal X and Y directions and in the vertical direction and rotatably so as to transfer the wafer W to and from the transfer stages TRS3 in the etching block S5 and the transfer stages TRS2 in the etching block S5. In the present embodiment, the etching unit 80 is configured so as to control an etching rate by adjusting etching process conditions, such as the frequency of high frequency waves and voltage applied in a vacuum atmosphere, and process gas pressure.

The housing 70a of the etching block S5 is provided with an electromagnetic shield to prevent electromagnetic waves generated from the etching unit 80 from leaking to the outside during dry etching and from adversely affecting the outside. As this shield, a shielding plate made of a conductive metal or synthetic resin can be used. With the present embodiment, the housing 70a is formed using a shielding plate 81 made of an aluminum alloy.

As shown by the solid arrow in FIG. 1, the wafer W can be transferred between the resist coating and developing apparatus 10 and the etching apparatus 12 by use of a carrier device (not shown). In this case, it is possible either to collectively transfer a plurality of the wafers W stored in the carrier 20 or to transfer them one by one.

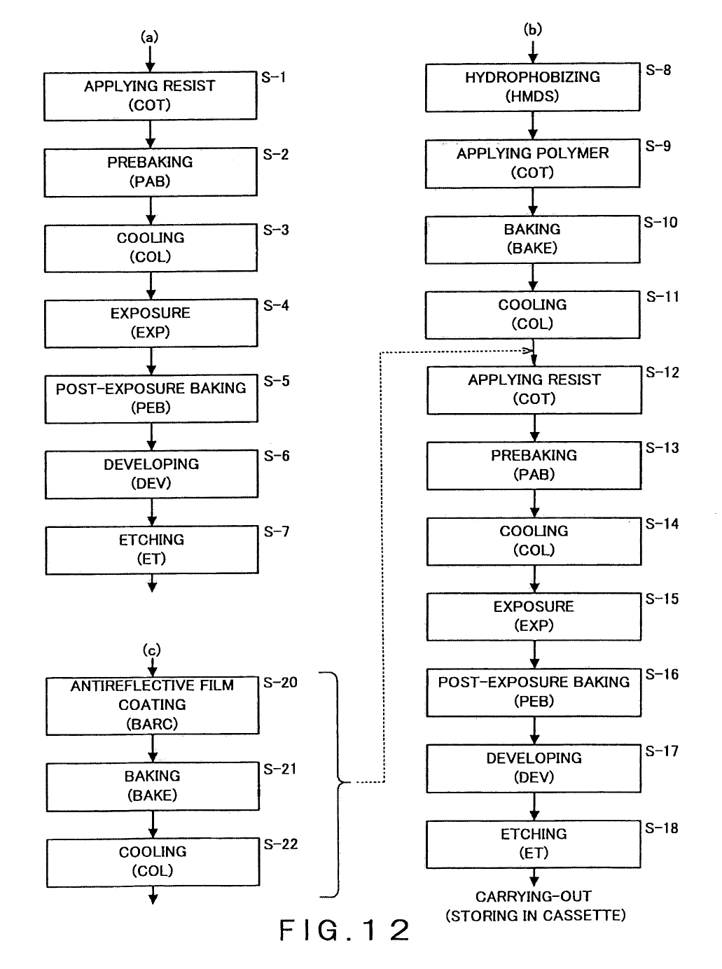

Then, a series of processing performed for the wafer W by use of the resist coating and developing system will be explained below with reference to the flow chart shown in FIG. 12.

First, a carrier 20 storing therein a wafer W to be processed is placed on a table 21 of the carrier block S1 in front of a shutter 22 thereof. In this state, the detection means 23 detects an identification tag assigned to the carrier 20, transmits a detection signal to the controller 60, and determines whether the processes (lithography process and etching process) to be performed from now to the wafers W in the carrier 20 is the first processes or second or more times processes. If it is judged “the first”, a transfer schedule for the first processing is created (the transfer schedule can also be created in advance), and the first lithography process is performed based on the transfer schedule.

Specifically, the wafer W that is temporarily stored in the unit rack U5 after being hydrophobized is taken out thereof by the main arm A2 and then transferred to the resist coating unit 32. Then, a resist film is formed on the wafer W (Step S-1). Subsequently, the wafer W is transferred to the heating unit (CLHP) by the main arm A2 and then subjected to pre-baking (PAB) in the heating unit, thereby evaporating the solvent from the resist film (Step S-2). Then, the wafer W is subjected to cooling treatment in the heat treatment unit (CLHP) (Step S-3). Although not shown in the flow chart, upon completion of the pre-baking (PAB), the wafer W is transferred to the edge exposure units (WEE), subjected to edge exposure treatment therein, and then subjected to heat treatment and foregoing cooling treatment. Subsequently, the wafer W is transferred to the exposure apparatus 11 by the interface arm D and then subjected to predetermined exposure process therein (Step S-4).

The exposed wafer W is transferred to the transfer stage TRS2 in the unit rack U6 by the interface arm D so as to be transferred to the DEV layer B2. The wafer W on the stage TRS2 is received by the main arm A1 of the DEV layer B2, subjected to post-exposure baking in the heat treatment unit (PEB) in the DEV layer B2 (Step S-5), and controlled to a predetermined temperature by use of a cooling plate (not shown) in the heat treatment unit (PEB). Subsequently, the wafer W is taken out of the heat treatment unit (PEB) by the main arm A1, transferred to the developing unit 31, and coated with the developing solution based on a processing recipe created by the recipe creation means 100 (Step S-6). Then, the wafer W is transferred to the heat treatment unit (POST) by the main arm A1 to be subjected to a predetermined developing process.

The developed wafer W is stored in an empty carrier 20 placed on the table 21 of the carrier block S1 and then transferred out of the coating and developing apparatus 10.

The wafer W that completed the first lithography process by the resist coating and developing apparatus 10 is transferred to the carrier block S1 of the etching apparatus 12 and subjected to an etching process using a resist pattern formed by the lithography process as a mask (Step S-7). Then, the wafer W is stored in the carrier 20 and then transferred again into the carrier block S1 of the resist coating and developing apparatus 10.

When the carrier 20 which stores the wafer W that completed the first lithography process and the first etching process is placed on the table 21 of the carrier block S1, the identification tag assigned to the carrier 20 is detected by the detection means 23. In this case, it is judged that the lithography process to be performed from now to the wafers W in the carrier 20 is the second process. Then, the controller 60 checks the previous (first) transfer history. After checking the previous transfer history, with reference to the previous (first) transfer schedule, the controller 60 creates a transfer schedule, in which, regarding a processing unit(s) of a particular type(s) (a processing unit such as the developing unit, the post-exposure baking unit, the etching unit that performs a process wherein a slight difference in processing conditions caused by individual difference between the processing units has a comparatively large influence on a processing result) among the processing units of various types to be used for the lithography process, the same processing unit is used in the first and second lithography process. The n-th (second) lithography process is performed based on that transfer schedule.

When the carrier 20 storing therein the wafer W that completed the first lithography process and the first etching process is loaded into the coating and developing apparatus 10, the wafer W in the carrier 20 is taken out thereof by the transfer arm C and then transferred to the transfer stage TRS1 on the unit rack U5. Then, the wafer W is transferred to the hydrophobizing unit (ADH) by the main arm A2, subjected to a hydrophobizing process therein (Step S-8), and temporarily stored in the unit rack U5. Subsequently, the wafer W is taken out of the unit rack U5 by the main arm A2 and transferred to the coating unit 32 in which the wafer W is coated with a sacrificial film made of a polymer material (Step S-9). Subsequently, the wafer W is taken out of the coating unit 32 by the main arm A2, transferred to the heat treatment unit (CLHP), subjected to baking, for example, for 90 seconds in an atmosphere at a temperature of 300 to 350□ (Step S-10), and then subjected to cooling treatment (Step S-11).

Then, the wafer W is transferred to the coating unit 32 by the main arm A2 and subjected to resist coating process, and as a result, a resist film is formed on the surface of the sacrificial film (S-12). In this case, since the surface of the sacrificial film is flat, the surface of the resist film also becomes flat, thus improving the in-plane uniformity of the resist film.

The wafer W having a resist film formed thereon is subjected to pre-baking treatment (PAB) (Step S-13), cooling treatment (Step S-14), and exposure process (EXP) (Step S-15) in that order, like the first lithography process. Upon completion of the exposure process, the wafer W is subjected to post-exposure baking using a PEB processing unit (Step S-16). By performing the second post-exposure baking process by use of the post-exposure baking unit used for the first post-exposure baking process, it is possible, particularly when a chemical amplification type resist is to be used, to minimize the difference in processing conditions that affect acid catalyst reaction, such as processing time, processing temperature, etc., in the first and second post-exposure baking processes. Subsequently, the wafer W is transferred to the developing unit 31 and subjected to developing process based on a processing recipe created by the recipe creation means 100 (Step S-17).

The wafer W that completed the second lithography process as mentioned above is stored in an empty carrier 20 placed on the carrier block S1 by the transfer arm C. Then, the carrier 20 storing the wafer W therein is transferred to the etching apparatus 12 and subjected to etching process using the pattern formed in the second lithography process as a mask. The sacrificial film remaining on the surface of the wafer W is removed through ashing.

Through a series of processes shown above, an additional pattern can be inserted between patterns with a pitch P formed by the first lithography process to form a pattern with a pitch P/2 as a whole, thereby the line width can be reduced. The wafer W that completed the second etching process is stored in the carrier 20.

Although an antireflective film is not formed in the foregoing embodiment, it can be formed at the top and bottom of the resist film. Specifically, the surface of the wafer W that completed the first lithography process and the first etching process is subjected to a hydrophobizing process, and then a sacrificial film is formed on the surface of the wafer W. The wafer W is further subjected to baking and cooling treatment, and then an antireflective film is formed on the surface of the sacrificial film. After a resist film is formed on the surface of the antireflective film, exposure process and developing process can then be performed. In this case, as shown in FIG. 12(c), antireflective film coating process (Step S-20), baking process (Step S-21), and cooling treatment (Step S-22) are added between the cooling treatment (Step S-11) and the resist coating process (Step S-12).

Further, although the lithography process and etching process are each performed twice in the foregoing embodiment, it is possible to repeat the lithography process and the etching process three times or more.

Further, although the foregoing embodiment uses a resist coating and developing system provided with the etching apparatus 12, the resist coating and developing system may not include the etching apparatus 12.

Further, although the substrate to be processed is a semiconductor wafer in the foregoing embodiment, it may be a substrate other than a wafer, for example, a LCD glass substrate.

1. A system which makes it possible to determine whether or not a new operation recipe is applicable to a substrate processing apparatus, the apparatus including a plurality of functional components which operate to perform predetermined tasks to a substrate, and a controller comprising a computer which controls operations of the plurality of functional components based on an operation recipe including a plurality of operation parameters, said system comprising:
said substrate processing apparatus; and
an electronic medium that can be attached to and detached from the computer of the substrate processing apparatus, or is connected to the computer of the substrate processing apparatus through a communication medium, the electronic medium being readable by the computer of the substrate processing apparatus,
wherein:
the electronic medium stores the new operation recipe; and
the electronic medium or the computer stores a judgment program, executable by the computer, for determining whether or not the new operation recipe stored in the electronic medium can be executed the functional components.

2. The system according to claim 1, wherein:
the judgment program is stored in the electronic medium.

3. The system according to claim 1, wherein:
the judgment program is configured so as to determine whether or not specifications of the functional components themselves and/or specifications of software stored in the controller for controlling the operation of the functional components are compatible with the new operation recipe stored in the electronic medium, thereby determining whether or not the new operation recipe stored in the electronic medium is executable.

4. The system according to claim 1, wherein:
the judgment program has a function to, if the judgment program determines that the new operation recipe stored in the electronic medium is unexecutable, judge the reason therefor and displays it on a display unit.

5. The system according to claim 1, wherein:
the computer of the substrate processing apparatus has a function to automatically determine, based on a part or parts of the plurality of operation parameters, the remaining operation parameters; and
the judgment program is configured so as to instruct the computer to determine, based on a part or parts of the plurality of operation parameters included in the new operation recipe stored in the electronic medium, the remaining operation parameters, and so as to compare the operation parameters thus determined with corresponding ones stored in the electronic medium thereby to determine whether or not the new operation recipe stored in the electronic medium is executable.

6. The system according to claim 1, wherein:
a plurality of new operation recipes are stored in the electronic medium; and
the judgment program is provided with a function to display preferable new operation recipes on the display in an order determined based on a predetermined criteria if there are a plurality of new executable operation recipes.

7. The system according to claim 1, wherein:
the substrate processing apparatus includes a liquid processing unit for performing a predetermined liquid process to the substrate, and the plurality of functional components include functional components that are provided in the liquid processing unit for performing an operation to discharge a processing liquid from a nozzle to supply a predetermined processing liquid to the substrate and for performing an operation to adjust a relative position of the nozzle to the substrate; and
the new operation recipe is a processing recipe that defines a procedure for the liquid process to be performed by the liquid processing unit.

8. The system according to claim 1, wherein:
the substrate processing apparatus includes a plurality of processing units that perform processes to the substrate, and a conveyer that transfers the substrate between the plurality of processing units;
the plurality of functional components include functional components for operation of the conveyer; and
the new operation recipe is a transfer recipe that defines a procedure for transferring the substrate to be performed by the conveyer.

9. An electronic medium for providing a substrate processing apparatus with a new operation recipe, the apparatus including a plurality of functional components which operate to perform predetermined tasks to a substrate, and a controller comprising a computer which controls operations of the plurality of functional components based on an operation recipe including a plurality of operation parameters;
wherein the electronic medium stores the new operation recipe including a plurality of operation parameters; and
wherein the electronic medium further stores a judgment program, executable by the computer, for determining whether or not the new operation recipe stored in the electronic medium can be executed the functional components.

10. A method of applying a new operation recipe to a substrate processing apparatus, the apparatus includes a plurality of functional components which operate to perform predetermined tasks to a substrate, and a controller comprising a computer which controls operations of the plurality of functional components based on an operation recipe including a plurality of operation parameters, said method comprising the steps of:
connecting an electronic medium storing the new operation recipe, which has been separated from the computer, to the computer so that the recipe can be read by the computer;
retrieving the new operation recipe from the electronic medium by means of the computer; and
executing a judgment program by means of the computer to determine, by using the judgment program, whether or not the new operation recipe stored in the electronic medium can be executed by the functional components.
